(19) United States
(12) Patent Application Publication
(10) Pub. No.: US 2006/0286913 A1
(43) Pub. Date: Dec. 21, 2006

(54) Sausage in a textile casing and methods for the automated production of the same

(76) Inventors: Walter Niederstaetter, Eltville (DE); Bernd Adolf Lang, Wiesbaden (DE); Udo Kunezel, Geisenheim (DE); Gerhard Grolig, Moerfelden-Walldorf (DE); Peter Wolf, Ostercappeln (DE); Kalle Gmbh, Wiesbaden (DE)

Correspondence Address: ProPat, 425 C South Sharon Amity Road, Charlotte, NC, 28211, US

(21) Appl. No.: 10/548,508

(22) PCT Filed: Mar. 16, 2004
(86) PCT No.: PCT/EP04/02692

§ 371 Date: Sep. 6, 2005

(30) Foreign Application Priority Data
Mar. 21, 2003 (DE) 103 13 878.1

(51) Int. Cl. A22C 13/02

(52) U.S. Cl. 452/22; 426/105

(57) ABSTRACT

The invention relates to a method for the automated production of sausages, according to which a tubular sausage casing is unwound section by section from a supply roll, gathered onto the filling tube of a filling machine and then detached from the latter. The invention also relates to a tubular sausage casing in roll form for use in said method and to a sausage with a lenght of 1 m or more, contained in a synthetic casing.

The invention relates to a method for the automated production of sausages, a tubular sausage casing being taken off in sections from a supply roll, shirred onto the stuffing tube of a stuffing machine and separated off. It also relates to a tubular sausage casing in roll form for use in this method, and also to a sausage having a length of 1 m or more in a artificial casing.

As an alternative to natural and collagen skins, and also to skins made of regenerated cellulose, textile skins have long been known, for example in the form of protein-coated fabric framework. Here, first a (seamless) textile hollow tube is produced from cotton, synthetic or silk fibers. This is divided into defined lengths which are then drawn on to a tube bearing compressed air. From there, the partial lengths are passed through an apparatus in which a collagen protein mass is applied to the surface of the tube. The amount applied is of a size such that the gaps in the fabric are closed. Excess protein mass is taken off by a doctor knife. After drying, the tube pieces can be wound up. The protein-coated fabric framework skin is permeable to water vapor and is therefore suitable for producing sliceable raw sausage varieties (G. Effenberger, Wursthüllen—Kunstdarm [Sausage casings—synthetic skin], 2nd edition [1991], Holzmann Buchverlag, Bad Wörishofen, pp. 25 and 106-108). However, in this manner only relatively short skin sections can be produced, which is disadvantageous for an automatic stuffing system.

Smokeable acrylate-coated textile sausage skins are also known (DE-A 31 47 519). The textile base material used therein can be a consolidated web, a spun web or a fabric of natural fibers and/or synthetic fibers. Those which are mentioned are fibers of cotton, linen, wool, silk, cellulose ester, regenerated cellulose, polyester, polyamide, polyacrylonitrile, polypropylene and poly(vinyl chloride). The base material is coated with an acrylate emulsion polymer based on lipophilic esters of (meth)acrylic acid with lower alkanols, in particular butyl acrylate. The coating is applied using customary coating apparatuses, such as air knife, roller coating knife, rubber sheet coating knife etc. By appropriate choice of the coating, the acrylate-coated textile skin can be set to be water vapor- and gas-permeable, so that it is also suitable for long-keeping sausage.

A textile skin may be produced, by appropriate incision and sewing together in virtually any desired shape, even an irregular shape, for example as a bladder.

For processing on an automatic stuffing system, the textile skin customary hitherto is virtually unsuitable. It generally has the shape of sewn sections which are individually stuffed, usually by hand. This is very labor-intensive, and thus costly.

DE-A 101 11 136 relates to a method and an apparatus for separating off tube sections from tubular endless roll good which has been laid flat. The roll good can consist of a textile material. In short distances, it has transverse closures and transverse seams. Before stuffing, the roll good is constantly soaked.

A method and an apparatus for automated production of sausages are disclosed in DE-A 32 23 725 (≈U.S. Pat. Nos. 4,580,316 and 4,625,362). In this method, first tubular material is taken off in relatively long lengths in sections from a supply roll, axially shirred on the stuffing tube of a sausage stuffing machine and separated off. The casing is then stuffed in portions with sausage emulsion, divided and closed. The stuffing machine described specifically comprises two stuffing tubes arranged on a revolving disk. Further tube material is shirred onto a tube, while the stirred tubular material is taken off again from the other tube during stuffing. The type of the tubular material is not defined more closely. To produce pizza salami, in particular from what are termed pepperoni sausages, the method is, however, less suitable. Pizza salami sausages are relatively long (about 80 to 200 cm), so that the shirred tubular length frequently cannot be optimally utilized. Tubular residues which cannot be utilized further are left behind.

A similar method and a similar apparatus are described in DE-C 31 06 074. Here also, first a tubular casing is taken off from a supply roll. It is drawn by the open end onto a sleeve which is then pushed onto the stuffing tube of a sausage stuffing machine. The sleeve is drawn back and the casing is closed and separated off before the end of the stuffing tube. Generally, casing sections are drawn on which are no longer, or not essentially longer, than the stuffing tube. Shirring the casing on the stuffing tube is therefore not actually performed. The apparatus also permits the internal soaking of an outer-coated tubular casing. Otherwise, the soaking is performed in a separate water-filled vessel. Soaking is always accompanied by a hygiene risk, since the soaking bath is very easily contaminated with microorganisms. Furthermore, soaking or spraying with water is an additional working step.

No details are given on the type of casings to be used. For very long sausages, such as pizza salami, the method is only suitable with very great limitations. The raw sausage emulsion would have to pass through a very long stuffing tube, as a result of which it changes in an adverse manner.

For this reason, pizza salami has hitherto solely been produced individually by hand stuffing. For this, sections which are closed at one end, premoistened by immersion in a water bath or spraying with water were manually shirred onto a relatively short stuffing tube, and then stuffed with emulsion in portions. An automation, for example according to the method described in DE-A 32 23 725 failed because, very frequently, a not inconsiderable part of the shirred casing remains over, because it is no longer long enough for a further pizza salami.

Starting from DE-A 32 23 725, the object was therefore to modify the method described there in such a manner that, in the production of the relatively long pizza salamis, cutting waste is no longer produced. The method is to proceed virtually fully automatically, so that in usual operation, no additional labor is required. In the method, as far as possible a textile skin is to be used which may be processed without soaking. The textile skin must, furthermore, be sufficiently permeable to water vapor, atmospheric oxygen and, if appropriate, also smoking aroma constituents, so that the pizza salami can if appropriate be smoked and ripened.

The object is achieved by a method in which in each case only as much of the tubular textile skin is taken off from the roll as is required for a single pizza salami. The skin is then shirred onto a relatively short stuffing tube, separated off and closed at the resultant end.

The present invention therefore relates to a method for the automated production of sausages in which a tubular sausage casing is taken off in sections from a supply roll, shirred onto the stuffing tube of a sausage stuffing machine and separated off, in which case the method comprises the tubular sausage casing being a water vapor- and smoke-permeable textile skin having a longitudinal seam in roll form, of which in each case only as much is taken off, shirred on the stuffing tube, separated off and closed at the resultant end as is required for a single raw sausage.

The textile skin comprises as base material a woven fabric, knitwear, consolidated nonwoven or spun nonwoven of natural fiber, synthetic fibers or mixtures thereof. Suitable natural fibers are, for example, cotton fibers, cellulose fibers (for example linen), wool or silk. Suitable synthetic fibers are, for example, fibers of polyamide, polyester, polyolefin (especially polypropylene), regenerated cellulose (=viscose staple), poly(vinyl acetate), poly-acrylonitrile or poly(vinyl chloride), or from the corresponding copolymers. Particular preference is given to a thin, longitudinally and transversely stretched fabric of cotton, viscose staple or a mixture of cotton and polyester, cotton and viscose staple or viscose staple and polyester having a weight per unit area of 8 to 300 g/m², preferably 20 to 150 g/m², particularly preferably 50 to 100 g/m².

Preferably, the base material is coated on one or both sides (including dip-coated=padded), laminated or surface-treated in another way. Substances which are suitable for this are particularly acrylate resins and plastic blends, especially emulsion polymers based on (C₁-C₆)alkyl(meth)acrylates, in particular butyl(meth)acrylate. The term (meth)acrylate here means as is customary acrylate and/or methacrylate. Units of other monomers can be included, for example those of styrene, β-methylstyrene or vinyl acetate. The fraction of units from such other monomers should not exceed 25% by weight, preferably 15% by weight. Suitable acrylate resins are known to those skilled in the art, in particular those from DE-A 31 47 519. Suitable materials for coating the base material are in addition viscose which is then regenerated to cellulose, and other coating liquids which comprise cellulose in derivatized or non-derivatized form. The base material can, in addition, be coated with collagen fibers, especially with beef collagen fibers. The thickness of the coating is chosen in such a manner that the water vapor- and oxygen-permeability required for ripening of the sausage is still present. A plurality of layers can also be applied. Suitable methods and apparatuses for coating are known in principle to those skilled in the art. In order not to impair the desired “textile” appearance of the sausage casing, the coating should not fill all of the interspatial spaces between the fibers.

During or after the coating the base material is expediently stretched in longitudinal and transverse direction. The extent of the stretching is dependent, inter alia, on the weight of the unit area, on the construction and on the type of the material. The area stretching ratio is generally 1 to 20% in the longitudinal and transverse direction, preferably 3 to 15%, in each case based on the raw product dimension. In the case of a light cotton or viscose staple fabric, or a mixed fabric of cotton and polyester, cotton and viscose staple or viscose staple and polyester having a weight per unit area of 50 to 100 g/m², for example stretching is performed to about 3 to 5% of the initial length or width. This prevents the casing from becoming thinner (that is to say forming what is termed a neck) at the end at which it is suspending and bulging at the bottom end, during later ripening and storage of the sausage.

In particular, a textile skin is suitable for the inventive method which has an extensibility during stuffing in the transverse direction of 1 to 10%. This ensures that the sausage may readily be stuffed, sits tightly on the filling and does not bulge when it is suspended during the ripening process.

The textile skin generally has a water vapor permeability (WVP) of greater than 50 g/m²d, preferably greater than 100 g/m²d, determined as specified in DIN 53122.

The base material, which is coated if appropriate, is then cut to the appropriate width, formed into a tube, for example using a forming collar, and fixed. Fixing can be performed by a sewn seam, a sealed seam and/or a glued seam. In the case of gluing the longitudinal edges of the material are generally laid over one another (overlapping gluing) or they are bonded together using a sealing or adhesive strip (tape). The longitudinal edges of the textile material can also be bonded together in such a way that a projecting part is formed. When the casing is later taken off, this part can be used as what is termed a tear tape.

The textile skin used in the inventive method generally has a diameter (nominal caliber) from 30 to 120 mm, preferably from 40 to 80 mm. For pizza salami, a caliber of about 45 to 55 mm has proved to be expedient. The textile skin is rolled up. On a roll there are situated expediently at least 500 m, preferably at least 900 m, of the skin, more precisely without a (transversely running) adhesive site and without transverse seam. A roll length of 700 to 2500 m is particularly expedient.

The textile skin to be used in the inventive method is preferably stuffed dry, i.e. presoaking or premoistening is not required, but may be expedient in exceptional cases. If appropriate, the case is oiled, for example using a triglyceride, a vegetable or synthetic oil, in particular a paraffin.

The textile skin is taken off from the roll in an exactly predetermined manner in the length customary for raw sausage, especially pizza salami. For raw sausage this is about a length of 40 to 80 cm, for pizza salami significantly more (about 80 to 200 cm, preferably 120 to 180 cm). It is then applied to a relatively short tube of the stuffing apparatus and shirred. The tube generally has a relatively large diameter (about 28 to 60 mm) and a length of 20 to 60 cm, preferably about 25 cm. The apparatus itself can have a structure as is described in DE-A 32 23 725.

After the textile skin has been drawn onto the stuffing tube, it is cut to the predetermined exact length and, before the end of the stuffing tube, fitted with an initial closure. This is expediently a metal or plastic clip, but can alternatively be a yarn binding or a closure produced by twisting and gluing or welding, if appropriate with the action of pressure. The initial closure, especially the initially clip, is advantageously bonded to a loop for suspending the sausage.

Preferably, the inventive method is carried out using an automated stuffing/clipping machine which has a plurality of stuffing tubes arranged so as to be able to rotate on a revolving head. An embodiment having a revolving head having 2 stuffing tubes has proved to be particularly expedient. The ready-to-stuff skin section is held by non-slip spring-mounted grippers and swung into the stuffing position in the rhythm of the stuffing/clipping sequence. Controlled via a length stop or stuffing portioner, the textile skin is stuffed with sausage emulsion, closed after injection is completed, and if appropriate automatically provided with a suspension loop. In parallel to the stuffing/clipping operation, on the free stuffing tube which is swung out, a new casing section is drawn on in an exactly predetermined length, closed and cut off. A dimensioning unit here determines the preselected casing length. A special opening and transport apparatus conveys the predetermined casing length via an internal support tube to a readied stuffing tube, pulls the casing tight, sets the closure if the support tube has moved back, and finally cuts the casing off.

The inventive method surprisingly permits a production rate at least just as fast as that disclosed by DE-A 32 23 725. Per hour, for example up to 1500 m of a pizza salami of a diameter of 45 to 55 mm may be produced.

The present invention therefore also relates to the use of the above described water vapor- and smoke-permeable textile skin in roll form in an automated method for producing raw sausage, preferably salami, particularly preferably pizza salami. The raw sausage in the textile skin can, if appropriate, also be heated.

The invention further relates therefore to a sausage in an artificial casing, the sausage having a length of 1 m or more, in which the casing is a textile skin. In a preferred embodiment, the sausage has a length of greater than 1.50 m, particularly preferably even greater than 1.60 m. The textile skin preferably has a longitudinal seam which can be produced by gluing, sealing, welding, sewing or in another manner. The sausage is in turn preferably a raw sausage, which can also be heated, however. Those which may be particularly mentioned are again pizza salami sausages.

1. A method for the automated production of sausages comprising taking off a tubular sausage casing in sections from a supply roll, shirring the tubular sausage casing on the stuffing tube of a sausage stuffing machine and separating off the shirred sausage casing, wherein the tubular sausage casing comprises a water vapor- and smoke-permeable textile skin having a longitudinal seam in roll form, of which in each case only as much is taken off, shirred on the stuffing tube, separated off and closed at the resultant end as is required for a single sausage.

2. The method as claimed in claim 1, wherein the textile skin comprises, as base material, a woven fabric, knitwear, consolidated nonwoven or spun nonwoven of natural fiber, synthetic fibers or mixtures thereof.

3. The method as claimed in claim 2, wherein the natural fibers comprise cotton, viscose staple, linen, wool or silk.

4. The method as claimed in claim 2, wherein the synthetic fibers comprise polyamide, polyester, polyolefin, regenerated cellulose, polyacrylonitrile and/or poly vinyl chloride.

5. The method as claimed in claim 2, wherein the base material comprises a longitudinally and transversely stretched fabric of cotton, viscose staple or a mixture of cotton and polyester, cotton and viscose staple, or viscose staple and polyester, the base material having a weight per unit area of 8 to 300 g/m².

6. The method as claimed in claim 2, wherein the base material is coated on one or both sides.

7. The method as claimed in claim 6, wherein the coating comprises acrylate resins, regenerated cellulose or collagen fibers.

8. The method as claimed in claim 1, wherein the textile skin has a water vapor permeability of greater than 50 g/m²d.

9. The method as claimed in claim 1, wherein the longitudinal seam is a sewn seam, a sealed and/or glued seam, or the longitudinal seam comprises a sealing or adhesive strip.

10. The method as claimed in claim 1, wherein the textile skin has a diameter (nominal caliber) of 30 to 120 mm.

11. The method as claimed in claim 1, wherein, on the supply roll, there are situated at least 500 m of textile skin that is free from transversely running adhesive sites and transverse seams.

12. The method as claimed in claim 1, wherein the textile skin is stuffed without presoaking or premoistening.

13. The method as claimed in claim 1, wherein the end of the textile skin which has been separated off is closed using a plastic or metal clip, by tying or by twisting and gluing or welding, optionally using pressure.

14. A textile skin in roll form as claimed in claim 1, wherein said textile skin has a longitudinal seam which is sewn, glued, or produced using a sealing or adhesive strip.

15. A cased sausage having a length of 1 m or more, said cased sausage comprising an artificial casing which further comprises a textile skin.

16. The sausage as claimed in claim 15, wherein it has a length of greater than 1.50 m.

17. The sausage as claimed in claim 15, wherein the textile skin has a longitudinal seam.

18. The sausage as claimed in claim 17, wherein a part of the textile skin projects beyond the longitudinal seam, thereby forming a tear tape.

19. The sausage as claimed in claim 15, wherein said sausage is a raw sausage.

20. A sausage as claimed in claim 15, wherein said sausage is a pizza salami.
